(19) United States
(12) Patent Application Publication
(10) Pub. No.: US 2008/0118888 A1
(43) Pub. Date: May 22, 2008

(54) DENTAL ARTICULATOR SYSTEMS AND METHODS

(76) Inventor: Kamil Karroum, Lawrenceville, GA (US)

Correspondence Address: CANTOR COLBURN, LLP, 20 Church Street, 22nd Floor, Hartford, CT, 06103, US

(21) Appl. No.: 12/020,828

(22) Filed: Jan. 28, 2008

Related U.S. Application Data
(63) Continuation-in-part of application No. 11/599,716, filed on Nov. 14, 2006.
(60) Provisional application No. 60/736,539, filed on Nov. 14, 2005.

(51) Int. Cl. A61C 11/00

(52) U.S. Cl. 433/54; 433/60

(57) ABSTRACT

Dental articulator systems and methods. Exemplary embodiments include an articulator apparatus, including a base having an upper surface, a first outer row of pins arranged along a portion of the base, a second inner row of pins arranged along another portion of the base adjacent the first outer row of pins and an inner platform located on the base adjacent the second inner row of pins. Exemplary embodiments include a dental articulator calibration system, including an elongate central body having an upper plate-receiving opening and a lower plate-receiving opening, an upper plate having a mating surface for mating with the upper plate-receiving opening and an articulator surface, a lower plate having a mating surface for mating with the lower plate-receiving opening and an articulator surface, a first articulator-specific base plate connected to the upper plate and a second articulator-specific base plate connected to the lower plate.

### CROSS-REFERENCE TO RELATED APPLICATIONS

This application is a continuation-in-part of U.S. patent application Ser. No. 11/599,716, filed Nov. 14, 2006, the entire contents of which are incorporated herein by reference, which claims priority to U.S. Provisional Application Ser. No. 60/736,539, entitled DENIAL ARTICULATOR SYSTEMS, filed on Nov. 14, 2005, the contents of which are incorporated by reference herein in its entirety.

### BACKGROUND

I. Field of the Invention

The present invention relates generally to the field dentistry and, more particularly to dental articulator systems and methods.

II. Description of the Related Art

Often times in dentistry, it becomes necessary for a dentist to fit a patient with a crown, bridge or even dentures. The tooth or teeth (collectively called teeth) are prepped, generally by taking an impression of the teeth of interest by pouring a molding material around the teeth and allowing it to harden. The mold is removed and sent to a lab in order to make a model of the teeth in preparation to create the crown, bridge denture and the like. Stone is poured into the impression so that, when hardened, a model of the teeth is created. Typically, a top and bottom jaw model is created. One use of the model is for use in an articulator, in which the model is fitted, so that the top and bottom pieces can be placed to simulate the actual bite of the patient. Therefore, during the pouring of the stone into the impression several additional steps are required such as adding pins into the wet stone for subsequent additional stone placement, which is subsequently affixed to an articulator base. The articulator base is typically proprietary for use with specific bases. As such, there exists no standard interface base that can be used with any articulator. More importantly, alignment jigs are used to align the jaws of an articulator. Such alignment jigs are non-standard and specific to proprietary articulators, which can be very costly. In addition, articulator joints must typically be added and connected to the stone.

### SUMMARY

Exemplary embodiments include an articulator apparatus, including a base having an upper surface, a first outer row of pins arranged along a portion of the base, a second inner row of pins arranged along another portion of the base adjacent the first outer row of pins and an inner platform located on the base adjacent the second inner row of pins.

In one implementation, the individual pins of the rows of pins are perpendicular to the upper surface.

In another implementation, the individual pins of the first outer row of pins have a height H.

In another implementation, individual pins of the second inner row of pins have a height h.

In another implementation, H is greater than h.

In another implementation, the inner platform is positioned above the upper surface thereby forming a perimeter wall around the platform.

In another implementation, the perimeter wall is adjacent the second inner row of pins

in still another implementation, the perimeter wall comprises a series of ridges adjacent the inner row of pins.

In yet another implementation, the apparatus further includes a half-hinge connected to a rear end of the base.

Further exemplary embodiments include a dental articulator calibration system, including an elongate central body having an upper plate-receiving opening and a lower plate-receiving opening, an upper plate having a mating surface for mating with the upper plate-receiving opening and an articulator surface, a lower plate having a mating surface for mating with the lower plate-receiving opening and an articulator surface, a first articulator-specific base plate connected to the upper plate and a second articulator-specific base plate connected to the lower plate.

In one implementation, the first articulator-specific base plate is connected to the articulator surface of the upper plate and the second articulator-specific base plate connected to articulator surface of the lower plate.

In another implementation, the mating surfaces of the upper and lower mating plates are for interconnection with a dental model plate.

Further exemplary embodiments include an articulator alignment kit, including a central alignment jig-blank, a first alignment plate for positioning on one end of the jig-blank, a second alignment plate for positioning on an opposite end of the jig-blank and an articulator-specific base plate connected to each of the first and second alignment plates, each articulator-specific base plate for connection to a respective upper and lower jaw of an articulator.

Additional exemplary embodiments include a method for aligning an articulator having an upper and lower jaw, including placing an alignment jig-blank between the upper and lower jaws, connecting an upper alignment plate combination on the upper jaw of the articulator, connecting a lower alignment plate combination on the lower jaw of the articulator, placing the upper and lower alignment plate combinations in contact with the alignment jig-blank and performing adjustments on the articulator jaws thereby aligning the articulator.

In one implementation, the upper alignment plate combination on the upper jaw of the articulator and the lower alignment plate combination on the lower jaw of the articulator each comprise a base alignment plate connected to an articulator-specific base plate.

Additional exemplary embodiments include a method of aligning a dental articulator, including pre-fitting an first proprietary mounting base to a first generic mounting base, pre-fitting an second proprietary mounting base to a second generic mounting base, connecting the first proprietary mounting base to a first generic mounting base combination to an upper jaw of an articulator, connecting the second proprietary mounting base to a second generic mounting base combination to a lower jaw of an articulator, placing an articulator alignment jig-blank between jaws of an articulator, placing the two combinations in contact with the articulator jig-blank and making alignment adjustments to the articulator jaws to accommodate the articulator jig-blank for subsequent affixation of a dental model between the jaws.

Further exemplary embodiments include a dental articulator apparatus, including a main articulator body, an upper jaw connected to the body, a lower jaw connected to the body and in opposition to the upper jaw, an upper proprietary mounting base connected to the upper jaw and an upper generic mounting base connected to the upper proprietary mounting base and a lower proprietary mounting base connected to the lower jaw and a lower generic mounting base connected to the lower articulator specific base;

Additional exemplary embodiments include a dental articulator system, including a dental articulator having an upper and lower jaw, an articulator base connected to each of the upper and lower jaws, an additional articulator base connected to each of the upper and lower articulator bases, wherein the upper articulator bases and the lower articulator bases are a first upper and lower articulator base combination, a articulator alignment jig-blank for connecting between the additional articulator bases and a dental model having an upper and lower jaw, wherein each of the upper and lower jaws each include a second upper and lower articulator base combination for connection to the upper and lower jaws of the articulator, the dental model having a bite pattern of a patient.

In one implementation, the jig-blank is for alignment of the articulator by placement in between the first upper and lower articulator combinations.

In another implementation, the first upper and lower base combinations are removable from the upper and lower jaws of the articulator.

In another implementation, the second upper and lower articulator combinations are connectable to the upper and lower jaws of the articulator to form a bite pattern matching the bite pattern of the patient.

Other objects, advantages and capabilities of the invention are apparent from the following description taken in conjunction with the accompanying drawings showing the preferred embodiment of the invention.

### BRIEF DESCRIPTION OF THE DRAWINGS

FIG. 1 illustrates a bottom perspective view of an exemplary embodiment of a dental articulator base;

FIG. 2 illustrates a top perspective view of an exemplary embodiment of a dental articulator base;

FIG. 3 illustrates a top perspective view of another exemplary embodiment of a dental articulator base;

FIG. 4 illustrates a top perspective view of an exemplary embodiment of a dental articulator mounting plate;

FIG. 5 illustrates a bottom perspective view of an exemplary embodiment of a dental articulator mounting plate;

FIG. 6 illustrates a side view of an exemplary articulator calibration jig; and

FIG. 7 illustrates an exemplary embodiment of a dental articulator system.

### DETAILED DESCRIPTION

One advantage of the invention is that the articulator apparatuses remove several model formation steps in creating dental models.

Another advantage of the invention is that the apparatuses retain the bite pattern of patient impressions.

Another advantage of the invention is that less stone is used in making dental models.

Another advantage of the invention is that articulator alignment can be made generic to a generic alignment jig.

Another advantage of the invention is that generic mounting bases can be interfaced to proprietary bases to create a generic mounting interface for any articulator.

Another advantage of the invention is that the apparatuses can be generically mounted to any articulator using the generic interface.

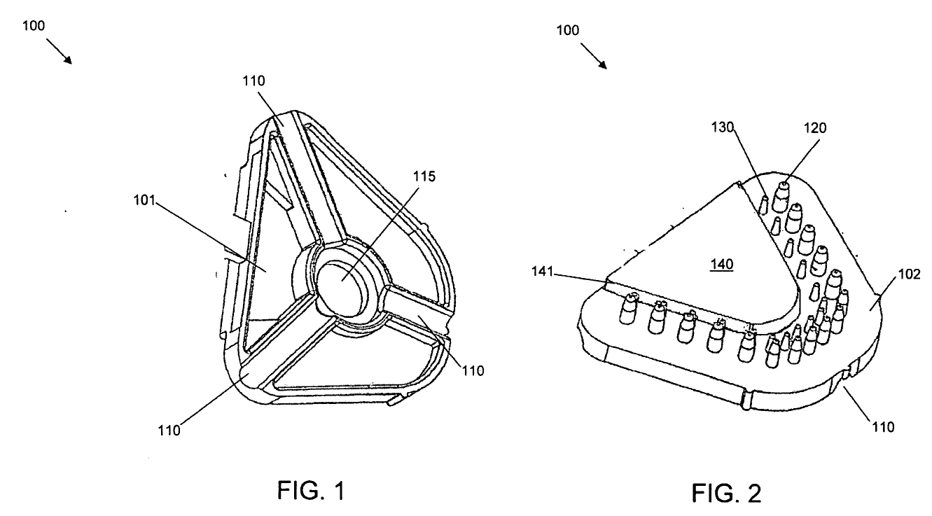

Referring to the drawings wherein like reference numerals designate corresponding parts throughout the several figures, reference is made to FIGS. 1-7 that illustrate several views of several embodiments of articulator systems.

FIG. 1 illustrates a bottom perspective view of an exemplary embodiment of a dental articulator base 100. As further described herein, the base 100 can include a lower surface 101 having female maters 110. The base 100 can further include an aperture 115 into which a magnet (shown below) can be fixed. FIG. 2 illustrates a top perspective view of an exemplary embodiment of the dental articulator base 100. The base 100 further includes an upper surface 102. In exemplary embodiments, the base 100 includes a first outer row of pins 120 arranged along a portion of the upper surface 102. In exemplary embodiments, the base includes a second inner row of pins 130 arranged along another portion of the upper surface 102 adjacent the first outer row of pins 120. The base 100 further includes an inner platform 140 positioned on the upper surface 102 adjacent the second inner row of pins 130. It is appreciated that an additional base is contemplated in opposition to the base 100 as described herein.

In general, several embodiments of articulator apparatuses are contemplated. It is appreciated that the apparatuses generally include an upper and lower jaw model base connected together in opposition by an integral hinge (not shown) pair. Alternatively, as described herein, a conventional articulator having manufacturer specific mounting plates can be implemented to align upper and lower jaw models as described herein. In exemplary embodiments, the integral hinge provides immediate alignment of the model because the stone is poured directly onto the upper and lower model bases when the impression is modeled. It is further appreciated that the articulators described herein can include upper and lower half-bases when it is desired to have models created from impression that have been taken on only one side of the patient's mouth.

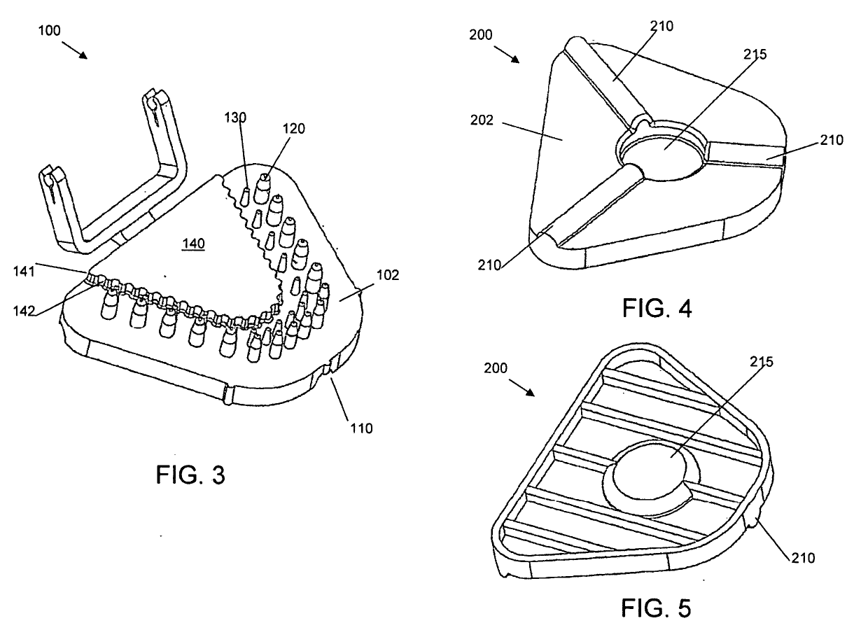

Typically, the individual pins of the rows 120, 130 of pins are perpendicular to the upper surface 102 of the base 100 and the individual pins of the first outer row of pins 120 have a height H. Furthermore, the individual pins of the second inner row of pins 130 have a height h. In exemplary embodiments, the height H is greater than height h. The inner platform 140 can be positioned above the upper surface 102 thereby forming a perimeter wall 141 around the platform 140, the perimeter wall 141 being adjacent the second inner row of pins 130. In exemplary embodiments, the perimeter wall can include a series of ridges 142 adjacent the inner row of pins 130 as illustrated in FIG. 3. However, it is appreciated that the perimeter wall 141 can have a smooth tapered profile. As mentioned above, the apparatus typically includes opposing, or upper and lower bases that are connected together by respective half-hinges connected to a rear end of each base.

In exemplary embodiments, model stone is poured directly onto each respective base 100 and the impression is placed directly onto the stone. Therefore, the stone dries directly onto the rows of pins 120, 130 and optionally to the ridges. By the impression being directly modeled onto the articulator bases, the exact bite is therefore formed because the articulators (or hinges) close onto the impression as the stone dries to create the model. When the stone dries, the impression is removed and the resulting bite of the model is the same as the bite of the impression as taken by from the patient. The stone can be removed from the base (generally silicone, spray or other suitable lubricant can be added prior to adding the stone to allow ease of removal.) The portion of the stone that is in contact with the articulator bases 100 now includes impressions from the rows of the pins 120, 130 and optionally the ridges 142. The combination of the pins 120, 130 and optionally the ridges 142 and the resulting impressions from the pins and ridges prevents virtually all unwanted movement of the model on the articulator, and further provides exact replacement of the model to the articulator when the model is removed and cut, sanded and otherwise modified when taking the necessary steps to create the dental crown, denture, etc. For example, if a crown is to be created, the tooth of interest on the model can be isolated by cutting it from the rest of the model. That particular tooth model includes respective hole and ridge impressions from the articulator. Therefore, regardless of how that tooth model is cut, it can be placed back into its precise location on the articulator where it is removed and it retains its the bite pattern with respect to the other model portions, upper and lower. This retaining of the bite pattern is possible because in general, the two rows of pins 120, 130 prevent side to side rotational and lateral movement. In exemplary embodiments, the ridges 142 prevent sliding from side to side and rotational movement. In general, it is appreciated that the pins 120, 130 and optionally the ridges 142 prevent virtually all freedoms of motion of the model and model portions. It is further appreciated that the pins are tapered from top to bottom to allow both ease of removal and insertion of the model onto the articulator as well as a snug fit by the taper being largest closest to the surface of the base 100.

In general, the bases 100 can include a series of support patterns to prevent warping and bending of the bases during use and to generally increase the overall strength of the base. In another implementation, the lower surface of the base opposite the model surface can include the aperture 115 to receive a coupling device such as a magnet to couple to an additional base for use with other articulators as described further below.

FIG. 4 illustrates a top perspective view of an exemplary embodiment of a dental articulator mounting plate 200. FIG. 5 illustrates a bottom perspective view of an exemplary embodiment of a dental articulator mounting plate 200. In exemplary embodiments, the mounting plate can include male maters 210 on an upper surface 202 of the plate 200. In exemplary embodiments, the plate 200 can further include an aperture 215 into which a magnet can be positioned as further described herein.

In exemplary embodiments, a dental articulator calibration system can be implemented to provide a standard for calibration of all proprietary articulators having manufacturer-specific mounting plates without the need to purchase individual expensive alignment/calibration jigs for each individual proprietary articulator.

FIG. 4 illustrates a perspective view of an exemplary articulator calibration jig system 600. In exemplary embodiments, the system 600 can include an elongate central body 601 having body pairs 602, between which a spacer 603 can be positioned depending on the length of a given articulator such as generic articulator 680. As such, it is appreciated that the elongate central body 601 can be varied to meet the differing calibration requirements of a given proprietary articulator such as generic articulator 680. Each of the body pairs can include a female mater 604 to receive a male mater 621 of a generic mounting plate 620 (such as the mounting plate as discussed in FIGS. 4 and 5 above). The mounting plates 620 can be coupled to an articulator-specific plate 610 via a suitable coupler such as stone 615.

In exemplary embodiments, the system 600 can also generally be available as an articulator alignment kit, generally including a central alignment jig-blank, which includes the elongate central body 601 having two or more of the body pairs 602 and a series of spacers 603. The kit can further include two mounting plates 620 that can be affixed to the articulator-specific plates 610; the articulator-specific plates 610 for connection to a respective upper and lower jaw of an articulator, such as generic articulator 680.

In addition, a method for aligning an articulator having an upper and lower jaw, generally includes placing an alignment jig-blank between the upper and lower jaws, connecting an upper alignment plate combination on the upper jaw of the articulator, connecting a lower alignment plate combination on the lower jaw of the articulator, placing the upper and lower alignment plate combinations in contact with the alignment jig-blank and performing adjustments on the articulator jaws thereby aligning the articulator.

In addition, the method of aligning a dental articulator, can also include pre-fitting a first proprietary mounting base to a first generic mounting base, pre-fitting a second proprietary mounting base to a second generic mounting base, connecting the first proprietary mounting base to a first generic mounting base combination to an upper jaw of an articulator, connecting the second proprietary mounting base to a second generic mounting base combination to a lower jaw of an articulator, placing an articulator alignment jig-blank between jaws of an articulator, placing the two combinations in contact with the articulator jig-blank and making alignment adjustments to the articulator jaws to accommodate the articulator jig-blank for subsequent affixation of a dental model between the jaws.

As such, any dental articulator apparatus, can include a main articulator body, an upper jaw connected to the body, a lower jaw connected to the body and in opposition to the upper jaw, an upper proprietary mounting base connected to the upper jaw and an upper generic mounting base connected to the upper proprietary mounting base and a lower proprietary mounting base connected to the lower jaw and a lower generic mounting base connected to the lower articulator specific base;

As a entire system, any dental articulator system, can include a dental articulator having an upper and lower jaw, an articulator base connected to each of the upper and lower jaws, an additional articulator base connected to each of the upper and lower articulator bases, wherein the upper articulator bases and the lower articulator bases are a first upper and lower articulator base combination, an articulator alignment jig-blank for connecting between the additional articulator bases and a dental model having an upper and lower jaw, wherein each of the upper and lower jaws each include a second upper and lower articulator base combination for connection to the upper and lower jaws of the articulator, the dental model having a bite pattern of a patient.

In exemplary embodiments, the jig-blank is for alignment of the articulator by placement in between the first upper and lower articulator combinations. In addition, the first upper and lower base combinations are removable from the upper and lower jaws of the articulator. Furthermore, the second upper and lower articulator combinations are connectable to the upper and lower jaws of the articulator to form a bite pattern matching the bite pattern of the patient.

It is therefore appreciated that any proprietary articulator can be aligned with the non-specific articulator alignment/calibration jig as described. For any given articulator, the proprietary bases of the given articulator can be pre-fitted with generic or non-specific articulator bases. In general, it is appreciated that the pre-fitting be a permanent fitting such as by glue of other suitable means. It is understood that the pre-fitting can also be non-permanent but strong such as by magnets. Therefore, the proprietary bases are fitted to be connected to the articulator jaws as normal. However, the generic bases are now affixed to the proprietary bases in opposition to one another. Therefore, the generic calibration jig can now be placed in between the generic bases for alignment procedure. It is therefore appreciated that the generic bases can be connected to any proprietary base pairs so that the inexpensive generic calibration jig can be used in any articulator because it interfaces with the generic bases attached to the proprietary bases.

Therefore, when models are made by permanently attaching proprietary bases to the stone of the model, generic bases can be permanently attached, instead of the proprietary bases, along with metal or a magnet. Therefore, when the model dries and is complete it can be interfaced with a mating generic plate that is connected to the proprietary base. It is understood that a single generic base can be used to create an impression on the drying stone and keep the metal or magnet in place when drying. Suitable lubricant can be used so that the generic base can be removed after drying. The model then includes an impression along with metal or a magnet that can be mated with an identical generic base that is pre-fitted to the proprietary base. The generic base in the combination includes a magnet to attract to the magnet or metal in the model. As such, by simple magnetic attraction, the model can be connected and disconnected to any articulator that includes any proprietary/generic base combination by virtue of the fact that generic base impression and the necessary metal or magnet is built into the model. Therefore, by creating this generic mounting base interface, models can be used with any articulator. It is appreciated that other coupling devices other than magnets are contemplated.

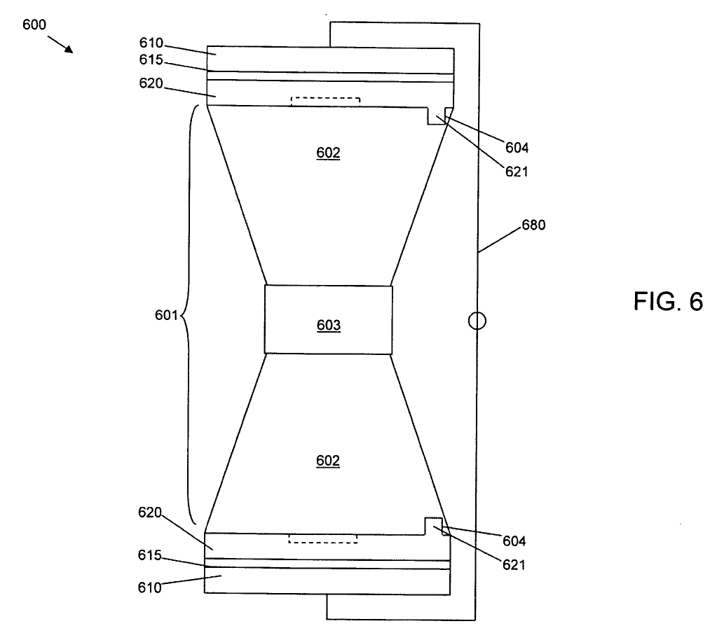

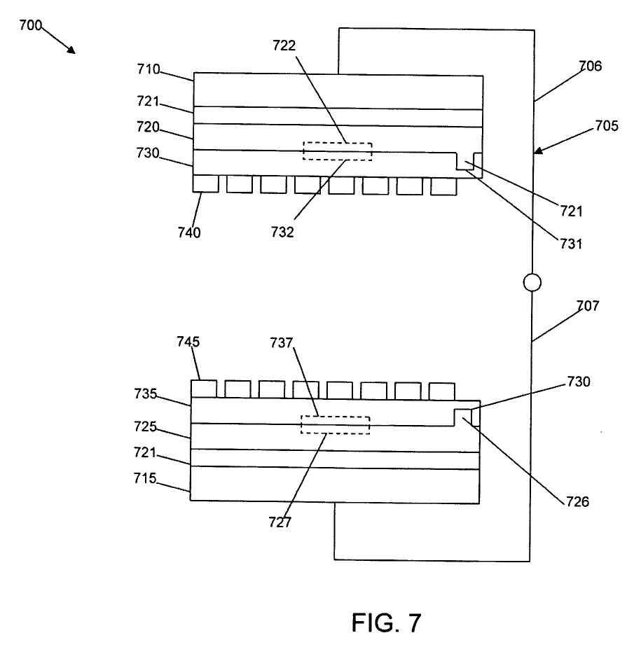

FIG. 7 illustrates an example of an articulator system 700 as just described. A manufacturer specific articulator 705 having and upper jaw 706 and a lower jaw 707 can include an articulator-specific upper mounting plate 710 and articulator specific lower mounting plate 715, respectfully coupled to the upper and lower jaws 706, 707. A respective upper and lower mounting plate 720, 725 as described herein can be coupled to the upper and lower articulator-specific mounting plates 710, 715, with stone 721 or other suitable material. It is appreciated that the system 700 has been previously aligned and calibrated as discussed with respect to FIG. 6 above. The system 700 can include upper and lower model bases 730, 735 having respective upper and lower jaw models 740, 745 that have been modeled onto the respective bases as described above. Each of the upper and lower mounting plates 720, 725 include a respective male mater 721, 726 and magnet 722, 727. Furthermore, each respective model base 730, 735 includes a female mater 731, 736 and magnet 732, 737. It is appreciated that the male maters 721, 726 and female maters 731, 736 and the magnets 722, 727, 732, 737 keep the respective mounting plates 720, 725 and model bases 730, 735 fixed with respect to each other. As such, having been previously aligned and calibrated, the articulator 705 maintained proper alignment with the upper and lower jaw models 740, 745.

Referring again to the above description of the articulator apparatuses, it is appreciated that the bases of those above-described apparatuses can be mated to the generic mounting bases as just described. Therefore, if it is desired to place one of the models created using the apparatuses into proprietary articulators, a magnet or metal can be added to the apparatus and the apparatus can mate directly with the generic base because the apparatus and the generic bases can be modeled to mate with one another.

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A dental articulator calibration system, comprising:
an elongate central body having an upper plate-receiving opening and a lower plate-receiving opening;
an upper plate having a mating surface for mating with the upper plate-receiving opening and an articulator surface;
a lower plate having a mating surface for mating with the lower plate-receiving opening and an articulator surface;
a first articulator-specific base plate connected to the upper plate; and
a second articulator-specific base plate connected to the lower plate.

2. The system as claimed in claim 1 wherein the first articulator-specific base plate is connected to the articulator surface of the upper plate and the second articulator-specific base plate connected to articulator surface of the lower plate.

3. The system as claimed in claim 1 wherein the mating surfaces of the upper and lower mating plates are for interconnection with a dental model plate.

4. A dental articulator system, comprising:
a dental articulator having an upper and lower jaw;
an articulator base connected to each of the upper and lower jaws;
an additional articulator base connected to each of the upper and lower articulator bases, wherein the upper articulator bases and the lower articulator bases are a first upper and lower articulator base combination;
a articulator alignment jig-blank for connecting between the additional articulator bases; and
a dental model having an upper and lower jaw, wherein each of the upper and lower jaws each include a second upper and lower articulator base combination for connection to the upper and lower jaws of the articulator, the dental model having a bite pattern of a patient.

5. The system as claimed in claim 4 wherein the jig-blank is for alignment of the articulator by placement in between the first upper and lower articulator combinations.

6. The system as claimed in claim 5 wherein the first upper and lower base combinations are removable from the upper and lower jaws of the articulator.

7. A dental articulator apparatus, comprising:
a main articulator body;
an upper jaw connected to the body;
a lower jaw connected to the body and in opposition to the upper jaw;
an upper proprietary mounting plate connected to the upper jaw and an upper generic mounting plate connected to the upper proprietary mounting plate; and
a lower proprietary mounting plate connected to the lower jaw and a lower generic mounting plate connected to the lower articulator specific plate.

8. The apparatus as claimed in claim 7 further comprising a model base configured to couple to each of the upper and lower generic mounting plates, the model bases each including:
an upper surface;
a first outer row of pins arranged along a portion of the model base;
a second inner row of pins arranged along another portion of the model base adjacent the first outer row of pins; and
an inner platform located on the model base adjacent the second inner row of pins.

9. The apparatus as claimed in claim 8 wherein individual pins of the rows of pins are perpendicular to the upper surface.

10. The apparatus as claimed in claim 8 wherein individual pins of the first outer row of pins have a height H.

11. The apparatus as claimed in claim 10 wherein individual pins of the second inner row of pins have a height h.

12. The apparatus as claimed in claim 11 wherein H is greater than h.

13. The apparatus as claimed in claim 8 wherein the inner platform is positioned above the upper surface thereby forming a perimeter wall around the platform.

14. The apparatus as claimed in claim 13 wherein the perimeter wall is adjacent the second inner row of pins.

15. The apparatus as claimed in claim 13 wherein the perimeter wall comprises a smooth continuous surface.
